(19) United States
(12) Patent Application Publication
(10) Pub. No.: US 2010/0044177 A1
(43) Pub. Date: Feb. 25, 2010

(54) FREE-WHEEL COMPRISING A BAND ELEMENT

(75) Inventor: Fritz Feldmeier, Nuernberg (DE)

Correspondence Address: COLLARD & ROE, P.C., 1077 NORTHERN BOULEVARD, ROSLYN, NY, 11576, US

(73) Assignee: PAUL MÜLLER GMBH & CO.KG UNTERNEHMENSBETEILIGUNGEN, Nürnberg (DE)

(21) Appl. No.: 12/312,338

(22) PCT Filed: Oct. 11, 2007
(86) PCT No.: PCT/DE2007/075009

§ 371 Date: Jul. 15, 2009

(30) Foreign Application Priority Data
Nov. 9, 2006 (EP) 06023345.9

(51) Int. Cl. F16D 41/06

(52) U.S. Cl. 192/45.1

(57) ABSTRACT

The invention relates to a free-wheel, particularly a clamping member free-wheel, comprising elements, especially an internal ring (1) and an external ring (2), which can be twisted relative to one another about a common axis, are arranged inside each other, and form a gap (4) inside which clamping elements, particularly clamping members (5), are disposed such that a frictional connection can be established to the facing external surfaces of the elements (1, 3) via clamping surfaces (6, 7) of the clamping members (5). The clamping members (5) are inserted into a clamping member cage (8) in order to be securely positioned. A circumferential band element (9) is provided which has recesses (10) for receiving the clamping members (5).

The invention relates to a free-wheel, in particular a clamping-member free-wheel, with the features of the preamble of claim 1.

In the case of directional couplings, non-symmetrical parts are arranged between two parallel straight or curved surfaces with which they must be held constantly in touching contact. Typical examples are clamping strips and directional couplings such as free-wheels, return-motion blocking devices and overrunning clutches. In what follows only the term free-wheel is used.

Free-wheels consist of two concentric rings with clamping elements which are arranged between the cylindrical inner face of the outer ring and the cylindrical outer face of the inner ring. The clamping elements have a non-symmetrical contour and are generally retained at uniform intervals in an annular spacer, the cage.

Apart from this cage, a resilient element which holds the clamping elements in permanent contact with the clamping faces is required.

A shaped spring bent from spring-steel wire as the resilient element is complex and costly to produce and very time-consuming to install manually.

It is the object of the invention to propose a free-wheel in which the clamping elements can be retained resiliently in an especially simple manner. The object is achieved by the features of the characterizing section of claim 1 in combination with the features of the preamble. Advantageous embodiments of the invention are described in the dependent claims.

According to the invention a spring band is used which does not project laterally beyond the cage and the clamping rings and has openings for receiving the clamping elements, which openings are congruent with the cage. The spring band of thin spring steel sheet rests in a form-fitting manner against the internal diameter of the cage and is held in its correct position by the clamping elements.

The spring steel sheet is bent up away from the cage on one longitudinal side of the opening, so that a resilient tab is produced which, firstly, prevents the clamping element from falling out and, secondly, exerts on the foot of the clamping element a tilting force which holds the clamping element securely in contact with the two clamping faces.

The spring band is punched endlessly and can be used for all diameters of free-wheels if, for example, the distance a between the openings is π or a multiple thereof.

The spring band is simply cut to length to match the circumferential length of the free-wheel diameter selected. Once cut to length, the spring band is placed in the cage and is automatically fixed when the clamping elements are installed.

The spring loading force can be adapted to the requirements by correct selection of the bending radius of the spring tab and the shaping of the spring tab.

The invention is described with reference to the following illustrations, in which:

FIG. 1 is a perspective representation of a band element;

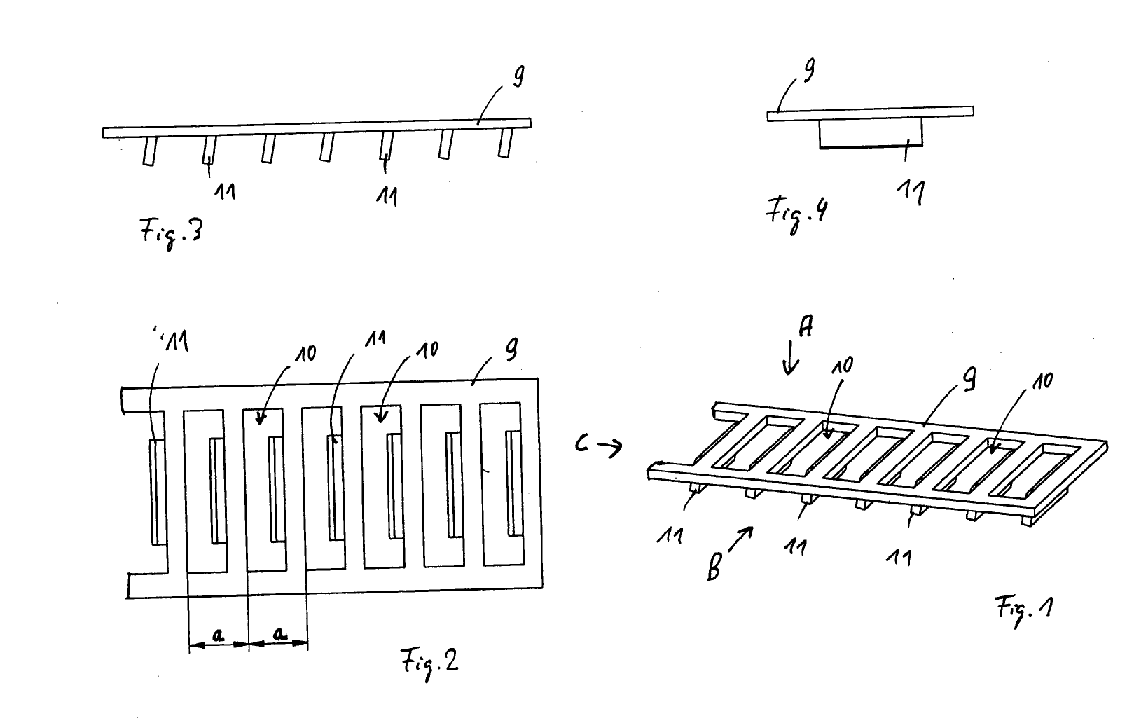

FIG. 2 is a view A according to FIG. 1;

FIG. 3 is a view B according to FIG. 1;

FIG. 4 is a view C according to FIG. 1;

FIG. 5 is a partial longitudinal section of the band element according to FIG. 1;

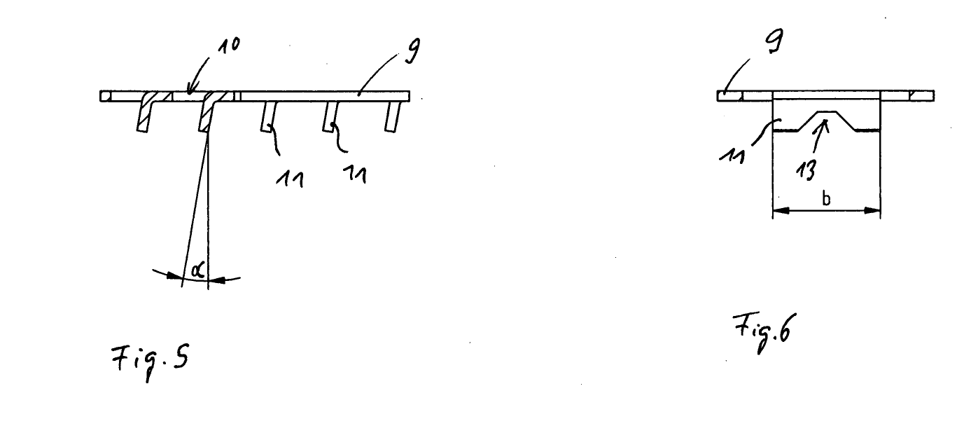

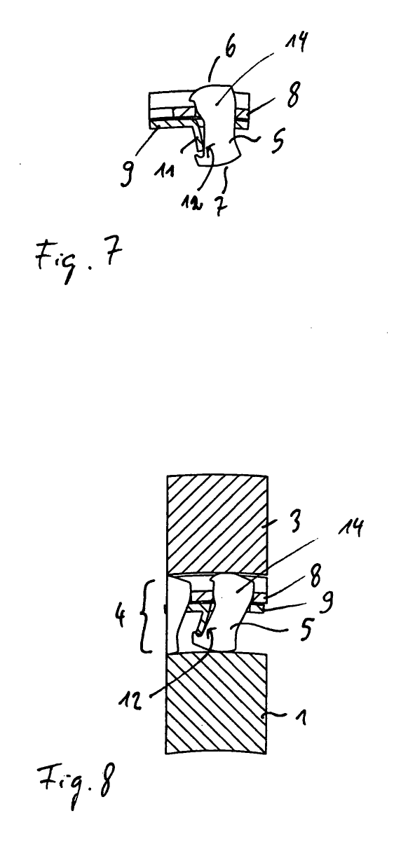

FIG. 6 is an alternative view A according to FIG. 1;

FIG. 7 is a detail of a free-wheel with band element installed, and

FIG. 8 is a detail of a free-wheel with band element installed in the operating state.

FIGS. 1-4 show a section of the endlessly punched band element 9 in a view from the top and side. The (punched) openings 10 with the bent tab elements (spring tabs) 11 for receiving the clamping members 5 are punched with a constant spacing a.

For universal application of the band element 9 it is advantageous to select the spacing a=π or a multiple thereof (depending on the size of the clamping members 5).

FIG. 3 shows a side view of an opening 10 with the bent spring tab 11. The length 1 of the spring tab 11 is not greater than the width of the opening 10 and must be coordinated with the recess (engaging lug) 12 of the clamping member 5.

The bending angle α of the spring tab 11 is adapted to the contour of the clamping member 5 and is selected such that the appropriate spring force acts on the clamping member 5. The spring force of the spring tab 11 can be influenced by means of the angle α.

In addition to the angle of incidence α, the width b of the spring tab 11 determines the spring force. The contact of the spring tab 11 against the clamping member 5 can be modified by means of one or more recesses 13 in the spring tab 11. The bending behavior. of the spring tab 11 can also be varied thereby.

FIGS. 6 and 7 represent the interaction of clamping member cage 8, band element 9 and clamping member 5. During assembly, the band element 9 is placed against the inner surface of the cage 8, so that—because it is very thin—it rests snugly against the cage 8. The clamping members 5 are then pushed from outside through the openings 10 of cage 8 and band element (spring band) 9, which openings are equal in size and congruent, until the spring tab 11 snaps into the recess 12 in the clamping member 5. The thickened portion 14 on the contour of the clamping member 5 prevents the clamping member 5 from falling through the opening 10.

1. A free-wheel, in particular a clamping-member free-wheel, comprising elements, in particular an inner ring (1) and an outer ring (2), which are arranged one inside the other about a common axis and form a gap (4) in which clamping elements, in particular clamping members (5), are arranged such that a frictional connection can be established with the facing cylindrical surfaces of the elements (1, 3) via clamping faces (6, 7) of the clamping members (5), the clamping members (5) being inserted in a clamping member cage (8) for secure positioning, wherein a circulatory band element (9) which has openings (10) for receiving the clamping members (5) is provided.

2. The free-wheel as claimed in claim 1, wherein the band element (9) has tab elements (11) for applying a pressure to clamping members (5) received therein.

3. The free-wheel as claimed in claim 1, wherein the tab elements (11) are arranged at an angle to the main body of the band element (9).

4. The free-wheel as claimed in claim 1, wherein the tab elements (11) are connected integrally to the band element (9).

5. The free-wheel as claimed in claim 1, wherein the tab elements (11) engage in a form-fitting manner in recesses (12) of the clamping members (5).

6. The free-wheel as claimed in claim 1, wherein the band element (9) is arranged in a circulatory manner parallel to the clamping member cage (8).
